(19) United States
(12) Patent Application Publication
(10) Pub. No.: US 2001/0042704 A1
(43) Pub. Date: Nov. 22, 2001

(54) Phyllosilicates

(75) Inventors: Sylvie Lacombe, Rueil Malmaison (FR); V?eacute;ronique Schlussel, Saint Louis (FR); Jacques Baron, Mulhouse (FR); Ronan Le Dred, Riedisheim (FR); Eric Benazzi, Chatou (FR)

Correspondence Address: MILLEN, WHITE, ZELANO & BRANIGAN, P.C., Arlington Courthouse Plaza 1, Suite 1400, 2200 Clarendon Boulevard, Arlington, VA, 22201, US

(73) Assignee: Institut Francois Du Petrole

(21) Appl. No.: 09/745,440

(22) Filed: Dec. 26, 2000

(30) Foreign Application Priority Data
Dec. 23, 1999 (FR) 99/16.381

(51) Int. Cl. C10G 47/04; B01J 21/16; C01B 33/22

(52) U.S. Cl. 208/210; 423/263; 423/326; 423/331; 423/332; 423/333; 502/80; 502/63; 208/209

(57) ABSTRACT

The present invention relates to trioctahedral phyllosilicates 2:1 of a stevensite or kerolite type containing fluorine, fluorinated in synthesis in an acid medium in the presence of hydrofluoric acid and/or another source of fluoride anions. The invention also relates to a method of preparation to obtain said phyllosilicate. The existence of gaps enables adjustable quantities of cations to be incorporated in the gaps and hence the exchange capacity of said solids to be modulated. These phyllosilicates, raw from synthesis or after post-synthesis modification, may be incorporated in the composition of catalysts used to convert hydrocarbons, in particular for hydrocracking.

The present invention relates to trioctahedral phyllosilicates 2:1 of the stevensite or kerolite type containing fluoride, fluorinated in synthesis in an acid medium in the presence of hydrofluoric acid and/or another source of fluoride anions. The invention also relates to a method of preparation to obtain said phyllosilicate. The invention additionally relates to a catalyst with a base of said phyllosilicate and the use of said catalyst to convert hydrocarbons and in particular for hydrocracking.

Phyllosilicates have a micro- or even meso-pore structure, attributable amongst other things to the nature, number and size of the compensation cations. The variation in the thickness of the space between sheets due to the exchange of compensation cations for other cations causes changes in properties. Phyllosilicates are used for adsorption and catalysis either as an active phase or as a means of assisting the active phase.

Due to the nature of the elements present in the tetrahedral and octahedral cavities and the nature of the compensation cations, the chemical composition of phyllosilicates is also an important factor affecting the selectivity of the exchange of cations, the adsorption selectivity and in particular the catalytic activity. This is explained by the nature and intensity of interactions between their internal and external surfaces on the one hand and with the adsorbed molecules on the other.

Numerous applications, particularly acid catalysis, require proton forms from which compensation cations introduced during synthesis have been completely removed. These forms may be obtained by one or more exchanges of these cations for NH₄⁺ions followed by calcination in order to generate the proton form.

Although the chemical bonds between the elements in the structure of phyllosilicates are ion-covalent, they will be assumed to be ionic here in order to simplify the description. Starting from a presentation in which the O²⁻ions are in one plane, in contact with one another, in the most compact manner, it is possible to obtain a plane having hexagonal cavities, referred to as a hexagonal plane, by removing one O²⁻ion in two from one of every two rows of O²⁻ions. The structure of a phyllite may be simply represented using arrangements of hexagonal planes of O²⁻Because the chemical compositions of talc (Si₄Mg₃O₁₀(OH)₂ and compounds of the stevensite and kerolite type ((Si₄Mg_{6-z}□_{z}O₁₀(OH)₂)^{z-} are very similar, phyllosilicate 2:1 has sometimes been regarded as a variety of talc. Natural stevensite occurs in veins or pockets, mixed to a greater or lesser degree with other phases, which may explain the difficulties encountered when attempting to characterise or sample it. However, progress in the systematic classification of natural phyllosilicates and improved analysis of samples has improved what we know about their characteristics.

### BACKGROUND OF THE INVENTION

Deposits of trioctahedral phyllosilicates 2:1 are known. However, their industrial applications are limited by their variable quality (presence of impurities). These problems have been the subject of major research with a view to synthesising phyllosilicates exhibiting the requisite qualities and desired properties. A distinction can be made between three main methods of preparing phyllosilicates: transformation of existing minerals, synthesis in a molten environment (absence of water, high temperature and high pressure) and hydrothermal synthesis. The third of these methods is the most interesting. It enables well crystallised phyllosilicates to be obtained under moderate operating conditions, close to those used in the case of zeolites, over reasonable synthesis periods.

The conditions of known methods of synthesising trioctahedral phyllosilicate 2:1 of the kerolite or stevensite type are based on those encountered in natural stevensite formation:

synthesis in a very dilute solution and at ambient temperature or slightly above (<100° C.) producing formation from the leaching waters,

hydrothermal synthesis under autogenous pressure forming minerals by hydrothermal alteration,

synthesis under high pressures in a molten environment.

Very broadly speaking, stevensite can be obtained by various methods of synthesis:

by heating a mixture of water, magnesium chloride, potassium hydroxide, calcium hydroxide and a hydrated silica to boiling point

operating a reaction at high temperature and high pressure between the magnesium oxide and the silicon oxide in aqueous medium

starting with very diluted solutions in a temperature range of from ambient to 100° C. at atmospheric pressure and for 200 days or more

by altering natural talc or gel of the same composition for a period in excess of 200 days and at temperatures of 300-450° C.

It has also been possible to produce a stevensite using various methods starting with magnesium carbonate and sodium silicate. They differ from one another by virtue of the proportions of reagents used, duration, temperature or sometimes the addition of other reagents.

All the synthesis processes described above are operated in a non-fluorinated medium. When conducting synthesis in a non-fluorinated medium, alkaline metals are introduced into the hydrogel. They are the source of the future compensation cations and have a mineralising effect. Alkaline metals may be substituted for the Mg²⁺ ion in the octahedral layer. This substitution has been observed in synthesised stevensite.

Generally speaking, it has been found that if fluorine is introduced as an element during synthesis in the place of the O—H groups, the phyllosilicates produced have an improved thermal stability. Secondly, introducing fluorine into the hydrogel enables the crystallisation period to be reduced, i.e. the time required to produce this phyllosilicate.

With the known methods, trioctahedral phyllosilicates 2:1 are synthesised in the presence of F⁻ions, usually in a basic medium, i.e. in a medium with a pH of 7, and at varying temperatures: a temperature in excess of 200° C. for rapid synthesis and ambient temperature for syntheses of longer duration. Patent specifications JP-87-292 615 and JP-87-292 616 in particular claim a range of products of the smectite type, i.e. a phyllosilicate having swelling properties, obtained in the presence of silicic acid, aluminium and magnesium salts, alkylammonium salts, salts of alkaline and alkaline earth metals and optionally fluorinated salts. French patent FR-A 1-2 682 371, on the other hand, claims trioctahedral phyllosilicates 2:1 and a method of preparing them in a fluorinated medium at a pH of less than 7. This relates to trioctahedral phyllosilicate 2:1 of the talc type or trioctahedral phyllosilicates 2:1 containing substitutions of appropriate elements after substitutions, either in the octahedral layer or in the tetrahedral layer.

### DESCRIPTION OF THE INVENTION

The objective of the present invention is to propose trioctahedral phyllosilicates 2:1 containing fluorine and having inter-sheet Mg²⁺ and a method of preparing them in acid medium, preferably slightly fluorinated, and in the absence of alkaline cations. The present invention may be extended to partial substitution of the magnesium in the synthesis medium by at least one element from the group consisting of cobalt, nickel and zinc. These solids are advantageously fluorinated in a fluoride medium, for example in the presence of HF acid or another acid source of fluoride ions and/or another source of fluoride anions.

What is original about the present invention is that the trioctahedral phyllosilicates 2:1 obtained have a composition in the octahedral layer which enables said solids to be identified as being trioctahedral phyllosilicates 2:1 of the stevensite or kerolite type. The presence of gaps means that variable quantities of cations can be incorporated in the gaps in a post-synthesis treatment by heating to temperatures below 250° C., which means that the capacity of said solids for exchange can be adjusted.

The advantage of the present invention is that because the synthesis method is applied to a medium containing no alkaline metals, the trioctahedral phyllosilicate 2:1 obtained by said invention is a purely magnesium-based mineral or, if desired, may contain a certain quantity of cobalt, nickel or zinc.

More specifically, the invention relates to crystallised trioctahedral phyllosilicates 2:1 of the stevensite or kerolite type, characterised by:

a) the general chemical formula (for a half lattice):

C_{2z/m}^{m+}Si₄(Mg_{3-z}□_{z})O₁₀(OH)₂₋ᵤFᵤ,n H₂O

where

C is the compensation cation constituted at least partially by the Mg²⁺ cation from the reaction medium or at least a cation introduced by at least one process of post-synthesis ion exchange, selected from the group consisting of the cations of elements from groups IA, IIA IIB and VIII of the periodic table, the cations of rare earths (cations of elements having an atomic number 57 to 71 inclusive), the ammonium cation, organic cations containing nitrogen (among which are alkylammonium and arylammonium),

m is the valence of the cation C,

z is a number greater than 0 and less than or equal to 1,

u is a number greater than 0 and less than or equal to 2, preferably less than or equal to 0.35 and most preferably less than or equal to 0.15,

n is a real positive number and not zero,

and □ stands for an octahedral cavity.

The magnesium element may be partially substituted by at least one of the elements from the group consisting of nickel, cobalt and zinc, these elements being taken from the reaction medium.

b) the X-ray diffraction diagram of a purely magnesium-based trioctahedral phyllosilicate 2:1 is characterised by the presence of the following rays:

a ray corresponding to a value of d₀₆₀ equal to 1.52±0.01 10⁻¹⁰ m

two other rays corresponding to values of dₕₖₗ equal to 4.53±0.05 10⁻¹⁰ m and 2.56±0.05 10⁻¹⁰ m

at least one reflection 001 such that d₀₀₁ is between 10.1 and 21.5 10⁻¹⁰ m in accordance with the chemical formula of said phyllosilicates. The reflection 001 enables a distinction to be made between trioctahedral phyllosilicate 2:1 of the kerolite type and trioctahedral phyllosilicate 2:1 of the stevensite type. A low value, somewhat less than 11.10⁻¹⁰ m, corresponds to kerolite and a higher value, somewhat higher than 11.10⁻¹⁰ m corresponds to stevensite. It should be pointed out that the boundary between kerolite and stevensite on a level with the ray d₀₀₁ is not very precisely defined.

The periodicity d₀₆₀ of 1.52×10⁻¹⁰ m enables the lattice parameter <<b>> to be calculated by means of the equation: b=6*d₀₆₀, i.e. 9.1×10⁻¹⁰ m. The lattice parameter <<b>> differs from that of as a person skilled in the art will be aware, and is 9.2×10⁻¹⁰ m. This difference should be accepted with precautions to account for uncertainties. The rays (hkl) of hydrated phyllosilicate are of an average intensity and relatively broad. The arrangement of the structure is not perfect.

Other properties may also be used to characterise the phyllosilicate proposed by the invention. For example, fluorinated trioctahedral phyllosilicate 2:1 of the stevensite or kerolite type as proposed by the invention exhibits at least one signal during analysis of the fluorine ¹⁹F by Nuclear Magnetic Resonance with Magic Angle Rotation (NMR-MAR), determined and known by the person skilled in the art. The chemical displacement of this signal depends on the composition of the octahedral layer. The NMR-MAR ¹⁹F spectrum of stevensite or kerolite type trioctahedral phyllosilicate 2:1 containing magnesium in the octahedral layer is characterised by an intense double signal centered on −175.0 and −176.6 ppm, CFCl₃ being used as a reference. A breakdown of this signal highlights two shoulders at −178.0 and 181.0 ppm.

The stevensite or kerolite type trioctahedral phyllosilicate 2:1 proposed by the invention is also characterised by specific swelling properties:

1) The periodicity d₀₀₁ measured using the X-ray diffraction technique varies by adsorption of organic molecules in the case of trioctahedral phyllosilicate 2:1 of the stevensite or kerolite type. In the case of the stevensite compound, the periodicity varies more sharply depending on the relative humidity P/P0 of the air. For example, the periodicity d₀₀₁ of 14.6×10⁻¹⁰ m measured in free air on a trioctahedral phyllosilicate 2:1 proposed by the invention changes to 15.2×10⁻¹⁰ when placed in equilibrium in air with a relative humidity P/P0=0.80 for three days and changes to 16.0×10⁻¹⁰ m after being dispersed in a solution of 14% glycerol in ethanol for one hour.

2) The swelling properties observed on the raw synthesis product disappear after heating for 12 h at 250° C. The X-ray diffraction diagram for stevensite or kerolite type trioctahedral phyllosilicate 2:1 when heated then exhibits a periodicity d₀₀₁ corresponding to that of a talc with an imperfect organisation. Under NMR-MAR analysis of the fluorine ¹⁹F, the probe used in the octahedral layer, the spectrum of the phyllosilicate proposed by the invention and based purely on magnesium, heated to 250° C. for 12 h, will have only one signal centered on −176.6 ppm which can not be broken down. This chemical displacement is attributed to the F(3 Mg) atoms, corresponding to fluorine atoms having three Mg in their environment. The Mg²⁺ cations present as compensation cations have migrated during heating to occupy the gaps in the octahedral position. The product obtained after heating no longer contains compensation cations. This specific property of the phyllosilicate proposed by the invention provides evidence of the fact that there are gaps in the octahedral layer.

For example, during NMR-MAR of ¹⁹F, the spectrum of the purely magnesium-based phyllosilicate exchanged with lithium and then heated exhibits two signals centered on −176.6 ppm and −183.0 ppm. The chemical displacement at −176.6 ppm is attributed to fluorine atoms having three magnesium in their environment, written F(3Mg). The second displacement is attributed to F(2Mg, Li) atoms, known to the person skilled in the art as natural trioctahedral phyllosilicate or hectorite. Li⁺ions have migrated from the inter-sheet space into the octahedral gaps, thereby providing evidence for the existence of octahedral gaps prior to heating.

The trioctahedral phyllosilicate 2:1 prepared as proposed by the invention is therefore of the stevensite or kerolite type.

The invention also relates to a method of preparing said stevensite or kerolite type trioctahedral phyllosilicates 2:1 proposed by the invention, which consists in:

a) forming a reaction mixture in aqueous solution having a pH less than 7, free of any alkaline metals, containing in particular water, at least one source of the silicon element, at least one source of the magnesium element and at least one source of the fluorine element,

in terms of molar ratio, said mixture having a composition within the following ranges cf values:

0<Mgₜₒₜₐₗ/Si≦50, preferably between 0.01 and 50,

0<F⁻ₜₒₜₐₗ/Si≦2 and preferably <0.35, preferably between 0.01 and 0.15,

5<H₂O/Si<500,

0<HF/Si<2 and preferably <0.35, preferably between 0.01 and 0.15.

F⁻ₜₒₜₐₗ, a representing the sum of F⁻ ions from all the fluoride sources and, for example, the HF acid or any other acid source of fluoride ions and/or any other source of fluoride anions, in particular MgF₂ and H₂SiF₆,

Mgₜₒₜₐₗ representing the sum of Mg⁺² ions from all the sources of the magnesium element and, for example, from MgF₂ if MgF₂ is used alone or partially as the source of F⁻ions. In a variant of the method, the magnesium source may be mixed with at least one source of the elements from the group consisting of cobalt, zinc and nickel.

b) said reaction mixture is maintained at a temperature below 250° C. and preferably below 220° C. until a crystalline compound is obtained.

During step b), the reaction mixture may advantageously be heated in an autoclave, the interior of which is advantageously coated with polytetrafluoroethylene, to a temperature below 250° C., preferably below 220° C., for a period which may vary from a few hours (for example 1 to 12) to several days ( from 1 day to a few days) depending on the reaction temperature, until a crystallised compound is obtained which is advantageously separated from the parent waters before being washed with distilled water and then dried.

Advantageously, said reaction mixture may be prepared to a pH ranging between 0.5 and 7 and preferably between 0.5 and 6.5.

In a preferred approach to preparing the triocathedral phyllosilicates 2:1 proposed by the invention, the molar ratios of the constituents of the reaction mixture are within the following ranges of values:

Mgₜₒₜₐₗ/Si:0.01-10,

F⁻ₜₒₜₐₗ/Si:0.01-0.15,

H₂O/Si:10-300,

HF/Si:0.01-0.15.

As an option, it is also possible to work accompanied by stirring and optionally in the presence of seeds of trioctahedral phyllosilicate 2:1 crystals.

The pH of the reaction medium, which is below 7, may be obtained directly using one or more reagents, or by adding an acid.

Numerous sources may be used for the silicon element, which might include, by way of example, silica in the form of hydrogels, aerogels, colloidal suspensions, silica produced by precipitating soluble silicate solutions or by hydrolysis of silica esters such as Si(OC₂H₅)₄, silica prepared by treatments to extract natural or synthetic compounds such as aluminium silicates, aluminosilicates, zeolites.

Among the sources for the magnesium element, for example, it is possible to use the oxide MgO, the hydroxide Mg(OH)₂, the salts such as magnesium chloride, fluoride, nitrate and sulphate, organic acid salts. The same types of source may be used for the nickel, cobalt and zinc elements if these partially substitute the magnesium.

Instead of using separate sources for the various elements mentioned above, it would also be possible to use sources combining at least two of the elements.

It seems surprising that the nature of the product obtained is dependent on the proportion of water and the proportion of fluoride in the reaction medium.

Similarly, the quantity of fluorine incorporated in the phyllosilicate depends on the proportion of fluoride in the medium.

The trioctahedral phyllosilicate 2:1 proposed by the invention also has specific swelling properties in the presence of compensation cations other than those present in the inter-sheet space after synthesis. In the raw synthesis product, these compensation cations are Mg²⁺ ions, optionally partially substituted by at least one of the elements from the group consisting of nickel, cobalt and zinc, if at least one of these elements is added to the reaction mixture.

These cations may be exchanged by post-synthesis treatment with cations of alkaline or alkaline earth metals. Advantageously, the phyllosilicate obtained after exchange is then heated to within a range of 60 and 550° C., preferably 60 and 250° C. for 1 hour up to 1 day, and preferably about 12 hours. If the cations exchanged are monovalent cations, the capacity of the phyllosilicate to exchange cations decreases after heating. If the cations exchanged are divalent cations, the phyllosilicate loses its swelling properties after heating.

The exchange is made, for example, by adding an aqueous solution containing the element or elements to be exchanged, then stirring at ambient temperature for one to several hours followed by centrifugation. The exchange may optionally be repeated and is preferably repeated twice. At the end of the exchange or exchanges, the product is washed with distilled water until the anions present in the solution have been removed, and then dried, for example for 48 h at 60° C.

If the exchange is conducted with a view to modifying the chemical composition of the solid, the cation may be selected from the group consisting of the cations of elements from groups IA, IIA, IIB and VIII of the periodic table, the cations of rare earths (cations of elements having an atomic number 57 to 71 inclusive), the ammonium cation, organic cations containing nitrogen (among which are alkylammonium and arylammonium). The element or elements to be exchanged may be selected from monovalent cations such as sodium or lithium, for example, and divalent elements such as calcium and manganese. By preference, the salts containing the element or elements to be exchanged are in chloride form.

The phyllosilicates obtained by synthesis after post-synthesis exchange may therefore be put through a heat treatment at a temperature ranging between approximately 60° and 550° C., preferably between 60 and 250° C., for approximately one hour up to one day, in order to produce a partial or total migration of the compensation cations towards free octahedral sites.

The capacity for exchange of the trioctahedral phyllosilicate 2:1 proposed by the invention can therefore be adjusted by acting on the nature of the exchanged ion and/or the temperature to which said compound is heated, raw from synthesis or having undergone a post-synthesis exchange.

In order to be used for acid catalysis, in particular to convert hydrocarbons, the compensating cations located in the inter-sheet space of the phyllosilicates proposed by the invention, raw from synthesis or exchanged during a post-synthesis treatment to adjust the capacity for exchange, must be replaced by H+ ions, for example by an exchange with ammonium nitrate followed by calcination. Accordingly, the phyllosilicate obtained after synthesis, having undergone a post-synthesis exchange with the ammonium cation, is heated to produce an acid solid in the H⁺ form.

The trioctahedral phyllosilicates 2:1 proposed by the invention may be used alone or as a mixture with a matrix. These phyllosilicates, single or in a mixture with at least one matrix, may be incorporated in the composition of catalysts and advantageously used to convert hydrocarbons, in particular for hydrocracking.

The matrices used are usually selected from the group consisting of alumina, silica, magnesia, titanium oxide, zirconium, boron oxide and combinations at least two of these compounds.

The matrix is preferably selected from the group consisting of silica, alumina, magnesia, silica-alumina mixtures, silica-magnesia mixtures and alumina-boron oxide mixtures.

The catalyst will then have a content by weight of stevensite or kerolite type trioctahedral phyllosilicate 2:1 proposed by the invention which is advantageously in the range of between 2 and 99.5%.

The catalyst containing the phyllosilicate proposed by the invention may contain at least one metal and/or metal compound chosen from groups IA, VIB and VIII of the periodic tale, for example platinum, palladium and/or nickel.

For hydrocracking applications, the charges used in the method are, for example, gas oils, gas oils under vacuum, residues with the asphalt removed or hydro-treated or equivalent. These may be heavy cuts constituted by at least 80% by volume of compounds whose boiling point is in excess of 350° C. and preferably less than 580° C. They generally contain heteroatoms such as sulphur and nitrogen. The nitrogen content is usually between 1 and 5000 ppm by weight and the sulphur content between 0.01 and 5% by weight. The hydrocracking conditions such as temperature, pressure, hydrogen recycling rates, hourly velocity by volume, may vary depending on the nature of the charge, the quality of the desired products and the installations used by the refiner.

Temperatures are generally in excess of 230° C. and commonly between 300° C. and 480° C., preferably less than 450° C. The pressure is greater than or equal to 2 MPa and in general higher than 3 MPa, even 10 MPa. The hydrogen recycling rate is a minimum of 100 and commonly between 260 and 3000 liters of hydrogen per liter of charge. The hourly velocity by volume is generally between 0.2 and 10 h⁻¹.

The following examples illustrate the invention but without limiting its scope.

### EXAMPLE NO. 1

### Synthesis of Trioctahedral Phyllosilicate 2:1 of the Kerolite Type

The following are added to 86.4 g of distilled water in succession and as specified:

0.8 g of 5% HF acid made up as a 40% dilution of the commercially available solution (Fluka)

4.1 g of magnesium acetate Mg(CH₃COO)₂, 4H₂O (Prolabo), accompanied by vigorous stirring,

1.5 g of powdered silicon oxide (SiO₂, Aerosil 130 from Degussa) accompanied by moderate stirring.

The molar composition of the hydrogel thus prepared, relative to one mole of oxide SIO₂ is approximately:

1.0SiO₂;0.75MgO;0.08HF;192H₂O

i.e., in terms of molar ratio

Mg/Si=0.75

F/Si=0.08

H₂O/SiO₂=192.

This composition does not take account of the water contributed by the magnesium source and HF acid.

The hydrogel thus obtained is cured for 2 hours at ambient temperature accompanied by moderate stirring. The pH is close to 5.5. Crystallisation then takes place in a steel autoclave with a coating of PTFE having a 120 ml capacity at 220° C. under autogenous pressure for 48 hours without stirring. The autoclave is then cooled by quenching.

The product is recovered, filtered and thoroughly washed with distilled water. The pH of the parent waters is in the order of 4. The product is dried for 48 hours at 60° C. The mass recovered is close to 2.1 g.

At the end of these 48 hours, the product obtained is placed in a desiccator containing a saturated solution of NH₄Cl with P/P₀=0.80 for 3 days. After these 3 days, the product is characterised by means of its X-ray diffraction diagram.

The reading is taken at ambient temperature and at a relative humidity P/P0 of 0.80.

| dₕₖₗ/10⁻¹⁰m | relative I |
|---|---|
| 10.7 | 63.0 |
| 4.54 | 100.0 |
| 3.17 | 17.0 |
| 2.60 | 53.0 |
| 1.72 | 19.0 |
| 1.52 | 83.0 |

### EXAMPLE NO. 2

### Synthesis of a Stevensite Type Trioctahedral Phyllosilicate 2:1

The following are added to 86.4 g of distilled water in succession and as specified:

0.4 g of 5% HF acid made up as a 40% dilution of the commercially available solution (Fluka)

4.1 g of magnesium acetate Mg(CH₃COO)₂, 4H₂O (Prolabo), accompanied by vigorous stirring,

1.5 g of powdered silicon oxide (SiO₂, Aerosil 130 from Degussa) accompanied by moderate stirring.

The molar composition of the hydrogel thus prepared, relative to one mole of oxide SIO₂ is approximately:

1.0SiO₂;0.75MgO;0.04HF;192H₂O

i.e., in terms of molar ratio

Mg/Si=0.75

F/Si=0.04

H₂O/SiO₂=192.

This composition does not take account of the water contributed by the magnesium source and HF acid.

The hydrogel thus obtained is cured for 2 hours at ambient temperature accompanied by moderate stirring. The pH is close to 6. Crystallisation then takes place in a steel autoclave with a coating of PTFE having a 120 ml capacity at 220° C. under autogenous pressure for 48 hours without stirring. The autoclave is then cooled by quenching.

The product is recovered, filtered and thoroughly washed with distilled water. The pH of the parent waters is in the order of 4. It is dried for 48 hours at 60° C. The mass recovered is close to 2.1 g.

At the end of these 48 hours, the product obtained is placed in a desiccator containing a saturated solution of NH₄Cl with P/P₀=0.80 for 3 days. After these 3 days, the product is characterised by means of its X-ray diffraction diagram.

The reading is taken at ambient temperature and at a relative humidity P/P0 of 0.80.

| dₕₖₗ (Å) | relative I |
|---|---|
| 11.2 | 23.0 |
| 4.51 | 72.0 |
| 3.12 | 40.0 |
| 2.59 | 57.0 |
| 1.72 | 25.0 |
| 1.52 | 100.0 |

### EXAMPLE NO. 3

### Synthesis of a Kerolite Type Trioctahedral Phyllosilicate 2:1

The following are added to 60.0 g of distilled water in succession and as specified:

1.1 g of 5% HF acid made up as a 40% dilution of the commercially available solution (Fluka)

11.2 g of magnesium acetate Mg(CH₃COO)₂, 4H₂O (Prolabo), accompanied by vigorous stirring,

4.2 g of powdered silicon oxide (SiO₂, Aerosil 130 from Degussa) accompanied by moderate stirring.

The molar composition of the hydrogel thus prepared, relative to one mole of oxide SIO₂ is approximately:

1.0SiO₂;0.75MgO;0.04HF;48H₂O

i.e., in terms of molar ratio

Mg/Si=0.75

F/Si=0.04

H₂O/SiO₂=48.

This composition does not take account of the water contributed by the magnesium source and HF acid.

The hydrogel thus obtained is cured for 2 hours at ambient temperature accompanied by moderate stirring. The pH is close to 5. Crystallisation then takes place in a steel autoclave with a coating of PTFE having a 120 ml capacity at 220° C. under autogenous pressure for 48 hours without stirring. The autoclave is then cooled by quenching.

The product is recovered, filtered and thoroughly washed with distilled water. It is dried for 48 hours at 60° C. The mass recovered is close to 6.6 g.

At the end of these 48 hours, the product obtained is placed in a desiccator containing a saturated solution of NH₄Cl with P/P₀=0.80 for 3 days. After these 3 days, the product is characterised by means of its X-ray diffraction diagram.

The reading is taken at ambient temperature and at a relative humidity P/P0 of 0.80.

| dₕₖₗ (Å) | relative I |
|---|---|
| 10.2 | 82.0 |
| 4.54 | 97.5 |
| 3.14 | 24.0 |
| 2.58 | 72.0 |
| 1.72 | 24.0 |
| 1.52 | 100.0 |

### EXAMPLE NO. 4

### Synthesis of a Kerolite Type Trioctahedral Phyllosilicate 2:1

The following are added to 86.4 g of distilled water in succession and as specified:

0.15 g of 5% HF acid made up as a 40% dilution of the commercially available solution (Fluka)

1.56 g of magnesium acetate Mg(CH₃COO)₂, 4H₂O (Prolabo), accompanied by vigorous stirring,

0.58 g of powdered silicon oxide (SiO₂, Aerosil 130 from Degussa) accompanied by moderate stirring.

The molar composition of the hydrogel thus prepared, relative to one mole of oxide SIO₂is approximately:

1.0SiO₂;0.75MgO;0.04HF;500H₂O

i.e., in terms of molar ratio

Mg/Si=0.75

F/Si=0.04

H₂O/SiO₂=500.

This composition does not take account of the water contributed by the magnesium source and HF acid.

The hydrogel thus obtained is cured for 2 hours at ambient temperature accompanied by moderate stirring. The pH is close to 6. Crystallisation then takes place in a steel autoclave with a coating of PTFE having a 120 ml capacity at 220° C. under autogenous pressure for 48 hours without stirring. The autoclave is then cooled by quenching.

The product is recovered, filtered and thoroughly washed with distilled water. The pH of the parent waters is in the order of 4. It is dried for 48 hours at 60° C. The mass recovered is close to 62 g.

At the end of these 48 hours, the product obtained is placed in a desiccator containing a saturated solution of NH₄Cl with P/P₀=0.80 for 3 days. After these 3 days, the product is characterised by means of its X-ray diffraction diagram.

The reading is taken at ambient temperature and at a relative humidity P/P0 of 0.80.

| dₕₖₗ (Å) | relative I |
|---|---|
| 10.7 | 79.6 |
| 4.57 | 100 |
| 3.21 | 27.0 |
| 2.61 | 43.0 |
| 1.72 | 14.0 |
| 1.52 | 63.0 |

### EXAMPLE NO. 5

### Synthesis of a Stevensite Type Trioctahedral Phyllo Silicate 2:1

The following are added to 86.4 g of distilled water in succession and as specified:

3.2 g of 5% HF acid made up as a 40% dilution of the commercially available solution (Fluka)

16.2 g of magnesium acetate Mg(CH₃COO)₂, 4H₂O (Prolabo), accompanied by vigorous stirring,

6.0 g of powdered silicon oxide (SiO₂, Aerosil 130 from Degussa) accompanied by moderate stirring.

The molar composition of the hydrogel thus prepared, relative to one mole of oxide SIO₂is approximately:

1.0SiO₂;0.75MgO;0.08HF;48H₂O

i.e., in terms of molar ratio

Mg/Si=0.75

F/Si=0.08

H₂O/SiO₂=48.

This composition does not take account of the water contributed by the magnesium source and HF acid.

The hydrogel thus obtained is cured for 2 hours at ambient temperature accompanied by moderate stirring. The pH is close to 6. Crystallisation then takes place in a steel autoclave with a coating of PTFE having a 120 ml capacity at 220° C. under autogenous pressure for 48 hours without stirring. The autoclave is then cooled by quenching.

The product is recovered, filtered and thoroughly washed with distilled water. The absence of parent waters means that the pH cannot be measured. It is dried for 48 hours at 60° C. The mass recovered is close to 11.20 g.

At the end of these 48 hours, the product obtained is placed in a desiccator containing a saturated solution of NH4Cl with P/P₀=0.80 for 3 days. After these 3 days, the product is characterised by means of its X-ray diffraction diagram.

The reading is taken at ambient temperature and at a relative humidity P/P0 of 0.80.

| dₕₖₗ (Å) | relative I |
|---|---|
| 17.2 | 51.0 |
| 4.50 | 89.0 |
| 3.20 | 31.0 |
| 2.60 | 73.5 |
| 1.72 | 31.0 |
| 1.52 | 100.0 |

### EXAMPLE NO. 6

### Synthesis of a Kerolite Type Trioctahedral Phyllosilicate 2:1

The following are added to 800.0 g of distilled water in succession and as specified:

6.40 g of 5% HF acid made up as a 40% dilution of the commercially available solution (Fluka)

28.86 g of magnesium acetate Mg(CH₃COO)₂, 4H₂O (Prolabo), accompanied by vigorous stirring,

10.67 g of powdered silicon oxide (SiO₂, Aerosil 130 from Degussa) accompanied by moderate stirring.

The molar composition of the hydrogel thus prepared, relative to one mole of oxide SIO₂ is approximately:

1.0SiO₂; 0.75MgO;0.09HF;250H₂O

i.e., in terms of molar ratio

Mg/Si=0.75

F/Si=0.09

H₂/SiO₂=250.

This composition does not take account of the water contributed by the magnesium source and HF acid.

The hydrogel thus obtained is cured for 2 hours at ambient temperature accompanied by moderate stirring. The pH is close to 5. Crystallisation then takes place in a steel autoclave with a coating of PTFE having a 1000 ml capacity at 220° C. under autogenous pressure for 48 hours without stirring. The autoclave is then cooled by quenching.

The product is recovered, filtered and thoroughly washed with distilled water. The pH of the parent waters is in the order of 4. It is dried for 48 hours at 60° C. The mass recovered is close to 17.5 g.

At the end of these 48 hours, the product obtained is placed in a desiccator containing a saturated solution of NH₄Cl with P/P₀=0.80 for 3 days. After these 3 days, the product is characterised by means of its X-ray diffraction diagram.

The reading is taken at ambient temperature and at a relative humidity P/P0 of 0.80

| dₕₖₗ (Å) | relative I |
|---|---|
| 10.2 | 35.5 |
| 4.58 | 100.00 |
| 3.15 | 17.0 |
| 2.60 | 50.0 |
| 1.72 | 18.0 |
| 1.52 | 75.0 |

### EXAMPLE NO. 7

### Synthesis of a Stevensite Type Trioctahedral Phyllosilicate 2:1

The following are added to 86.4 g of distilled water in succession and as specified:

1.50 g of 5% HF acid made up as a 40% dilution of the commercially available solution (Fluka)

4.10 g of magnesium acetate Mg(CH₃COO)₂, 4H₂O (Prolabo), accompanied by vigorous stirring,

1.5 g of powdered silicon oxide (SiO₂, Aerosil 130 from Degussa) accompanied by moderate stirring.

The molar composition of the hydrogel thus prepared, relative to one mole of oxide SIO₂ is approximately:

1.0SiO₂;0.75MgO;0.15HF;192H₂O

i.e., in terms of molar ratio

Mg/Si=0.7

F/Si=0.15

H₂/SiO₂=192.

This composition does not take account of the water contributed by the magnesium source and HF acid.

The hydrogel thus obtained is cured for 2 hours at ambient temperature accompanied by moderate stirring. The pH is close to 5. Crystallisation then takes place in a steel autoclave with a coating of PTFE having a 120 ml capacity at 220° C. under autogenous pressure for 48 hours without stirring. The autoclave is then cooled by quenching.

The product is recovered, filtered and thoroughly washed with distilled water. The pH of the parent waters is in the order of 4. It is dried for 48 hours at 60° C. The mass recovered is close to 2.3 g.

At the end of these 48 hours, the product obtained is placed in a desiccator containing a saturated solution of NH₄Cl with P/P₀=0.80 for 3 days. After these 3 days, the product is characterised by means of its X-ray diffraction diagram.

The reading is taken at ambient temperature and at a relative humidity P/P0 of 0.80.

| dₕₖₗ (Å) | relative I |
|---|---|
| 17.5 | 100 |
| 5.21 | 2 |
| 4.55 | 26 |
| 3.17 | 4 |
| 2.60 | 18 |
| 1.72 | 3 |
| 1.52 | 17 |

### EXAMPLE NO. 8

### Synthesis of a Stevensite Type Trioctahedral Phyllosilicate 2:1

The following are added to 800 g of distilled water in succession and as specified:

13.89 g of 5% HF acid made up as a 40% dilution of the commercially available solution (Fluka)

37.60 g of magnesium acetate Mg(CH₃COO)₂, 4H₂O (Prolabo), accompanied by vigorous stirring,

13.89 g of powdered silicon oxide (SiO₂, Aerosil 130 from Degussa) accompanied by moderate stirring.

The molar composition of the hydrogel thus prepared, relative to one mole of oxide SIO₂is approximately:

1.0SiO₂;0.75MgO;0.15HF;192H₂O

i.e., in terms of molar ratio

Mg/Si=0.75

F/Si=0.15

H₂O/SiO₂=192.

This composition does not take account of the water contributed by the magnesium source and HF acid.

The hydrogel thus obtained is cured for 2 hours at ambient temperature accompanied by moderate stirring. The pH is close to 7. Crystallisation then takes place in a steel autoclave with a coating of PTFE having a 120 ml capacity at 220° C. under autogenous pressure for 48 hours without stirring. The autoclave is then cooled by quenching.

The product is recovered, filtered and thoroughly washed with distilled water. The pH of the parent waters is in the order of 4. It is dried for 48 hours at 60° C. The mass recovered is close to 20.40 g.

At the end of these 48 hours, the product obtained is placed in a desiccator containing a saturated solution of NH₄Cl with P/P₀=0.80 for 3 days. After these 3 days, the product is characterised by means of its X-ray diffraction diagram.

The reading is taken at ambient temperature and at a relative humidity P/P0 of 0.80.

| dₕₖₗ (Å) | relative I |
|---|---|
| 18.0 | 100 |
| 5.30 | 1 |
| 4.55 | 30 |
| 3.29 | 5 |
| 2.58 | 15 |
| 1.72 | 3 |
| 1.52 | 14 |

### EXAMPLE NO. 9

### Exchange by Post-synthesis Treatment of a Kerolite Type Trioctahedral phyllosilicate 2:1

1 g of the phyllosilicate-Mg obtained from example I is added to 25 g of a 2 M lithium chloride solution. The mixture is stirred for 2 h at ambient temperature and is centrifuged. The exchange is repeated twice. The product obtained is washed with distilled water until the chlorides have been removed (tested using silver nitrate) and dried on a heated plate at 60° C. for 48 h. The exchange capacity of the solid thus obtained is 78 m²/100 g of clay calcined at 1000° C. In order to measure the exchange capacity, the compensation cations are exchanged for sodium ions, which are then metered by atomic absorption.

The phyllosilicate-Li thus obtained is heated to 250° C. for 12 h. After heating, it has an exchange capacity of 20 m²/100 g of clay calcined at 1000° C.

The preceding examples can be repeated with similar success by substituting the generically or specifically described reactants and/or operating conditions of this invention for those used in the preceding examples. Also, the preceding specific embodiments are to be construed as merely illustrative, and not limitative of the remainder of the disclosure in any way whatsoever.

The entire disclosure of all applications, patents and publications, cited above and below, and of corresponding French application 99/16.381, are hereby incorporated by reference.

From the foregoing description, one skilled in the art can easily ascertain the essential characteristics of this invention, and without departing from the spirit and scope thereof, can make various changes and modifications of the invention to adapt it to various usages and conditions.

1. Crystallised phyllosilicates 2:1 of the stevensite or kerolite type characterised by:
a) the general chemical formula (per half-lattice)
C_{2z/m}^{m+}Si₄(Mg_{3-z}□_{z})O₁₀(OH)₂₋ᵤFu,nH₂O
where
C is the compensation cation formed at least partially by the Mg²⁺ cation from the reaction medium or a at least one cation introduced by at least one post-synthesis ion exchange process, selected from the group consisting of the cations of elements from groups IA, IIA, IIB and VIII of the periodic table, the cations of rare earths (cations of elements having an atomic number 57 to 71 inclusive), the ammonium cation, the organic cations containing nitrogen,
m is the valence of the cation C,
z is a number greater than 0 and less than or equal to 1,
u is a number greater than 0 and less than or equal to 2,
n is a real positive number and not zero,
and □ stands for an octahedral cavity,
b) an X-ray diffraction diagram characterised by the presence of the following rays:
one ray corresponding to a value of d₀₆₀ equal to 1.52±0.01 10⁻¹⁰ m,
two other rays corresponding to values of dₕₖₗ equal to 4.53±0.05 10⁻¹⁰ m and 2.56±0.05 10⁻¹⁰ m,
at least one reflection 001 such that d₀₀₁ is between 10.1 and 21.5 10⁻¹⁰ m.

2. Phyllosilicate 2:1 as claimed in claim 1 such that the molar ratio F-Si is greater than 0 and less than or equal to 0.35.

3. Phyllosilicate 2:1 as claimed ion claim 1, such that the molar ratio F⁻/Si is greater than 0 and less than 0.15.

4. Phyllosilicate 2:1 as claimed in one of claims 1 to 3 such that the magnesium is partially replaced by at least one of the elements from the group consisting of cobalt, nickel and zinc.

5. Method of preparing phyllosilicates of the stevensite or kerolite type as claimed in one of claims 1 to 4, characterised in that
a) a reaction mixture is formed in aqueous solution having a pH less than 7 and free of alkaline minerals, containing in particular water, at least one source of the silicon element, at least one source of the magnesium element and at least one source of the fluorine element, said mixture having a composition, in terms of molar ratio, within the following ranges of values:
0<Mgₜₒₜₐₗ/Si<50
0<F⁻ₜₒₜₐₗ/Si<2
5<H₂O/Si<500
0≦HF/Si≦2
Mgₜₒₜₐₗ representing the sum of Mg⁺²ions from all the sources of the magnesium element,
F³¹ₜₒₜₐₗ representing the sum of F⁻ions from all sources of fluoride ions,
b) said reaction mixture is maintained at a temperature below 250°0 C. until a crystalline compound is obtained.

6. Method as claimed in claim 5, in which, during step b), the reaction mixture is heated in an autoclave to a temperature below 250° C. for a period which may vary from several hours to several days depending on the reaction temperature until a crystalline compound is obtained.

7. Method as claimed in one of claims 5 to 6, in which the magnesium source may be mixed with at least one source of the elements from the group consisting of cobalt, zinc and nickel.

8. Method of synthesis as claimed in one of claims 5 to 6, in which, at step a), said reaction mixture has a composition, in terms of molar ratio, in the following ranges:
0<Mgₜₒₜₐₗ/Si<10,
0<F^{-total}/Si<0.15,
10<H₂O/Si<300.
0<HF/Si<0.15.

9. Method of preparation as claimed in one of claims 5 to 8, in which an exchange is conducted post-synthesis of the prepared phyllosilicates with at least one cation chosen from the group consisting of the cations of elements from groups IA, IIA, IIB and VIII of the periodic table, the cations of rare earths (cations of elements having an atomic number 57 to 71 inclusive), the ammonium cation and organic cations containing nitrogen.

10. Method as claimed in one of claims 5 to 9, in which the phyllosilicates obtained by synthesis undergo, before or after exchange, a heat treatment at a temperature ranging between approximately 60° C. and 550° C.

11. Method of preparation as claimed in one of claims 5 to 10, in which, having undergone an exchange with the ammonium cation post-synthesis, the phyllosilicate obtained after synthesis is heated to produce an acid solid in the H⁺ form.

12. Catalyst containing a phyllosilicate as claimed in one of claims 1 to 4 or prepared as claimed in one of claims 5 to 11.

13. Catalyst as claimed in claim 12, also containing at least one matrix chosen from the group consisting of alumina, silica, magnesia, titanium oxide, zirconium, boron oxide.

14. Catalyst as claimed in one of claims 12 or 13 containing at least one element chosen from the group consisting of the elements in groups IA, VIB and VIII.

15. Use of the catalyst as claimed in one of claims 12 to 14 to convert hydrocarbons.

16. Use as claimed in claim 14 for hydrocracking.
